(19) United States
(12) Patent Application Publication
(10) Pub. No.: US 2006/0068898 A1
(43) Pub. Date: Mar. 30, 2006

(54) Game-credit card gaming system and method with incentives

(76) Inventor: Darren Maya, Reno, NV (US)

Correspondence Address: Bell, Boyd & Lloyd LLC, P.O. Box 1135, Chicago, IL, 60690-1135, US

(21) Appl. No.: 10/954,133

(22) Filed: Sep. 28, 2004

(51) Int. Cl. G06F 19/00; G06F 17/00

(52) U.S. Cl. 463/25

(57) ABSTRACT

A wagering gaming system, method and apparatus including a card purchased with an amount of money which a player may use to place wagers in gaming machines. The card is useable in a select gaming machines at a select gaming establishments. The card provides an additional game related benefit or game related incentive for the player using the card. The game related benefit or game related incentive is not provided to players who do not use the card. The game related benefit or game related incentive can be any suitable game related benefit or game related incentive such as an additional opportunity in a bonus game or an additional available award in a bonus game.

### BACKGROUND OF THE INVENTION

It is well known to provide a gaming device, most typically a slot machine or card gaming machine, that accepts money from a player, holds the money while the player plays the gaming device and enables the player to retrieve the player's money at any time. These gaming devices do not require the player to insert a wagerable amount of money in the gaming device each time the player wishes to play the game. When the player wins while playing known gaming devices, the gaming devices do not require the player to take the winnings if the player desires to continue play.

Known gaming devices provide a credit meter or display, which displays a pool of player's money temporarily stored by the gaming device. The pool can store an amount sufficient to play many games of the gaming device. The pool can also accumulate and store the player's winnings. When the player wishes to stop playing, known gaming devices provide a mechanism, such as a cash out input or button by which the player can retrieve the money that remains in the pool or on the player's credit or money meter.

Historically, known retrieval mechanisms include a cash out mechanism, which pays out the player's money in a desired denomination or form of money. Dollar slot machines (requiring at least a $1 wager) typically issue tokens redeemable for $1 when the player cashes out. Other slot machines can issue actual money such as nickels, dimes, quarters and half dollars. Known slot machines maintain a payout tray limit, such that an operator or attendant is called when the player wins or wishes to cash out an amount above the limit. The limit prohibits the player from having to handle a cumbersome or unsafe amount of coins and enables the machine to store a minimal number of tokens or coins at any one time.

Other modern gaming devices include ticketing systems. These machines issue a ticket to the player that includes the amount of the player's money printed on the ticket. In one embodiment, when the machine issues the ticket, the player can input the ticket into other gaming machines equipped for redeeming the tickets, or redeem the ticket for money from an operator attendant. The ticketing systems advantageously enable gaming to take place without the player having to handle tokens or coins.

Modern gaming devices thus provide a variety of ways in which to receive a wagerable amount from the player. The flexibility has caused certain gaming machines to have multiple different inputting areas for the various different types of payment, e.g., coin slots for coins and tokens, bill acceptors for cash and ticket acceptors for tickets. Further, many gaming devices include card acceptors that receive player tracking cards. Player tracking cards track the player's play within a casino. Casinos often compensate a player for a certain amount of play.

Many modern gaming devices are also networked. For example, casinos employ a player tracking network that tracks the player's wagering on multiple machines. Casinos having ticketing systems use a network to keep track of the ticket amounts through barcodes printed on the tickets. Machines therefore have at least some of the capability to run more interesting, fun and exciting payment and promotion schemes. A need therefore exists not only in continuing the development of gaming machines and gaming machine systems capable of implementing the schemes but also in developing the schemes themselves.

### SUMMARY OF THE INVENTION

The present invention provides an apparatus, method and system for inputting funds into a gaming device having a game operable upon a wager. The apparatus includes a card or other suitable type of member or storage device that is readily transported by the player. In one embodiment, the card can be purchased from a retail, service or other type of outlet. The card can be used, for example, as a gift card provided from the purchaser to a beneficiary. The card is provided in various embodiments by gaming device manufacturers, casinos or other persons or entities that desire to provide such a card.

When purchased, the purchaser can select a desired amount to purchase and transfer to the card. Alternatively, cards in one or more monetary amounts are pre-made, and the purchaser selects one of the predetermined amounts for the cards (e.g., a $50 card, or $100 card, etc.). Further alternatively, the cards are configured to have a pre-defined number of credits that are each worth a certain denomination, which are then used to play machines having the designated credit denomination.

The present invention contemplates enabling the user to travel to multiple machines within a casino and/or to multiple casinos and to use the game-credit card of the present invention wherever authorized. For example, the card can be authorized at any machine made by a particular manufacturer. The authorized machines are of a type having a particular kind of payment acceptor, such as a credit card or debit card acceptor. The player then transfers either a set amount or selectable amount of cash from the card to the gaming device, which converts the cash to useable game credits. Thereafter, the player plays the gaming device using credits transferred from the game-credit card of the present invention.

In one embodiment, the game-credit card provides a game related monetary or non-monetary incentive to the user of such card. For example, the card can provide an a different type of game of the gaming device than the game played via credits obtained from cash (such as a game with a better paytable or a paytable with incentives), invoke an eligibility for a particular game, provide non-monetary benefit such as a drink or food service or any combination thereof. In one embodiment, the player must transfer at least a portion of the credits from the game-credit card to the gaming device to achieve the game related monetary or non-monetary incentive. In one embodiment, the player must use or wager a designated portion of the credits or a designated monetary amount to receive the incentive.

The present invention contemplates multiple embodiments of different systems and methods for keeping track of the monetary amounts initially transferred to the game-credit cards. In one embodiment, the card and machine are operable to transfer all money to the machine to be converted to credits in a one-shot type of transfer. In another embodiment, each machine and card have the capability to re-record a remaining amount of money on the card when the player finishes playing. The player can then bring the card to a next machine, which reads the remaining amount. Here, the machines may but do not have to communicate over a system. In a third embodiment, a network and server computer are used to keep track of any amount remaining on the card after the first play using the card. Here, the card need only store enough information for the system to recognize which card is being used to access the appropriate account.

It is therefore an advantage of the present invention to provide a fun and exciting payment apparatus and method.

Another advantage of the present invention to provide a convenient form of gaming device payment.

A further advantage of the present invention to provide an apparatus and method for one person to give a gift to another person.

A further advantage of the present invention to network various machines to use a single game-credit card.

Moreover, it is an advantage of the present invention to provide a pre-purchasable card that causes the gaming device to provide a game related incentive to the user of the card.

Still a further advantage of the present invention is to provide a wagering system employing a game-credit card, wherein the system ensures that the player will use the card for gaming purposes and not simply to redeem the card for cash.

Additional features and advantages of the present invention are described in, and will be apparent from, the following Detailed Description of the Invention and the figures.

### BRIEF DESCRIPTION OF THE FIGURES

FIG. 1A is a front perspective view of one embodiment of the gaming device of the present invention.

FIG. 1B is a front perspective view of another embodiment of the gaming device of the present invention.

FIG. 2A is a schematic block diagram of one embodiment of an electronic configuration for one of the gaming devices of the present invention.

FIG. 2B is a schematic block diagram of one embodiment of a network configuration for a plurality of gaming devices of the present invention.

FIG. 3 is a perspective view of one embodiment of the game-credit card of the present invention.

FIG. 4 is an elevation view of one of the display devices of the gaming device showing various standard and optional features of the pre-purchasable game-credit card of the present invention.

FIG. 5 is an elevation view of one of the display devices of the gaming device showing a bonus game embodiment providing various monetary incentives or bonuses for using the pre-purchasable game-credit card of the present invention.

FIG. 6 is a schematic perspective view of a system architecture showing various local area and wide area networks capable of transferring information concerning the pre-purchasable game-credit card of the present invention.

### DETAILED DESCRIPTION OF THE INVENTION

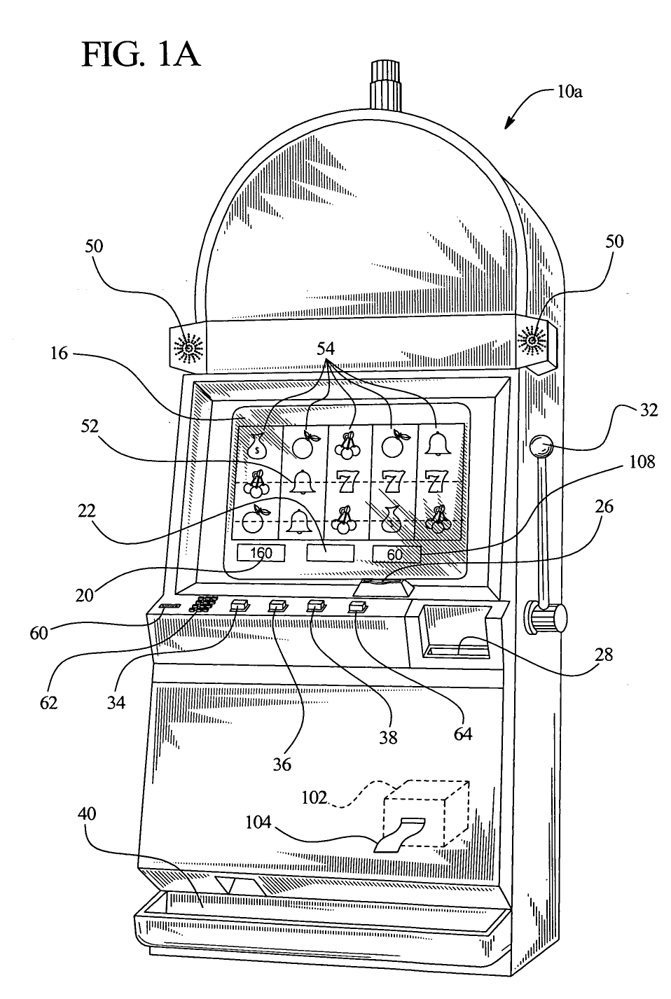

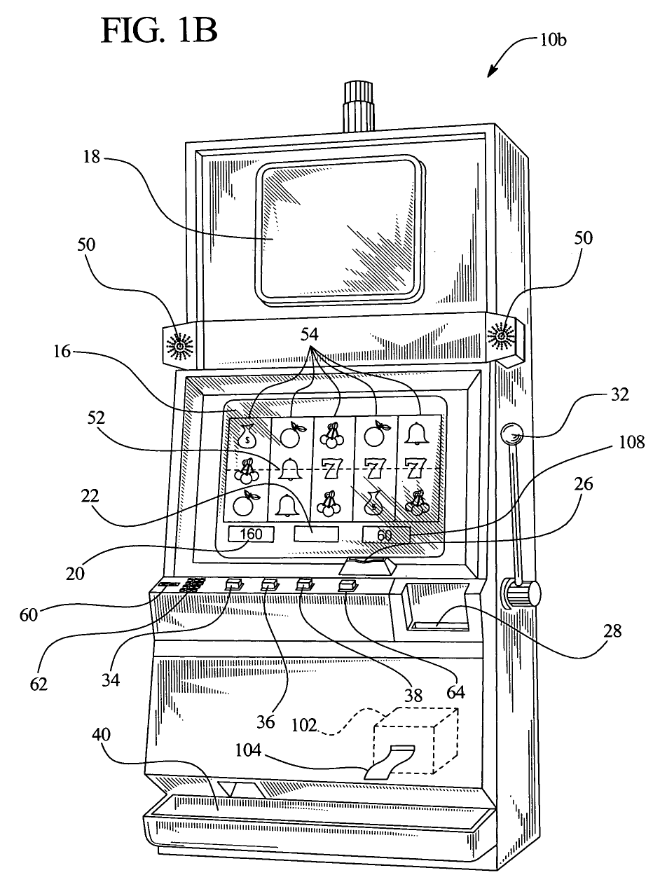

Referring now to the drawings, two alternative embodiments of the gaming device of the present invention are illustrated in FIGS. 1A and 1B as gaming device 10a and gaming device 10b, respectively. Gaming device 10a and/or gaming device 10b are generally referred to herein as gaming device 10.

In one embodiment, as illustrated in FIGS. 1A and 1B, gaming device 10 has a support structure, housing or cabinet which provides support for a plurality of displays, inputs, controls and other features of a conventional gaming machine. It is configured so that a player can operate it while standing or sitting. Gaming device 10 may be positioned on a base or stand or can be configured as a pub-style table-top game (not shown) which a player can operate in one embodiment while sitting. As illustrated by the different configurations shown in FIGS. 1A and 1B, gaming device 10 can be constructed with varying cabinet and display configurations.

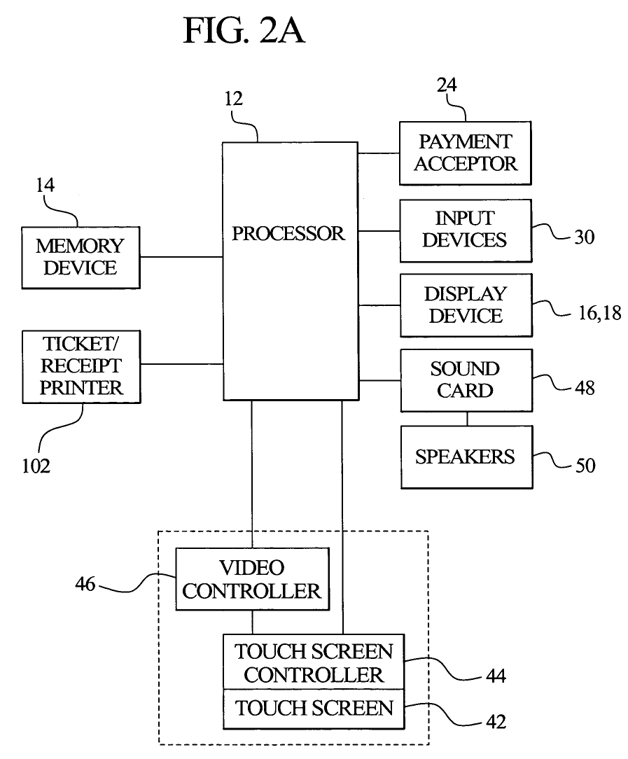

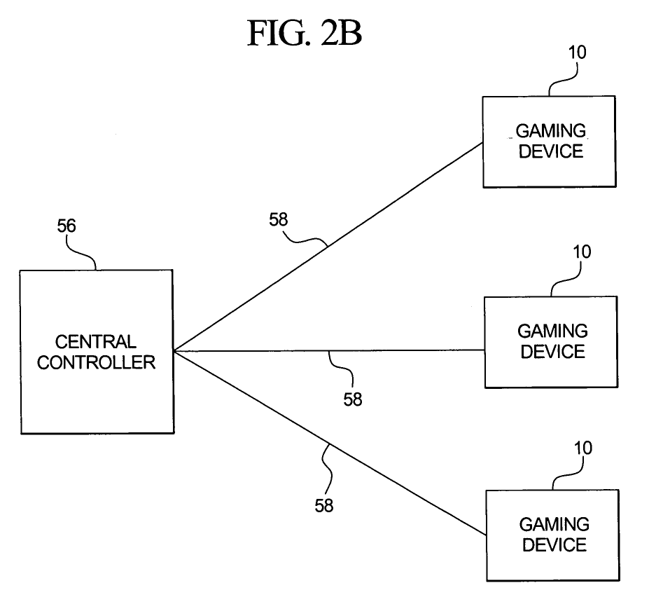

In one embodiment, as illustrated in FIG. 2A, gaming device 10 in one embodiment includes at least one processor 12, such as a microprocessor, a microcontroller-based platform, a suitable integrated circuit or one or more application-specific integrated circuits (ASIC's). Processor 12 is in communication with or operable to access or to exchange signals with at least one data storage or memory device 14. In one embodiment, processor 12 and memory device 14 reside within the cabinet of gaming device 10. Memory device 14 stores program code and instructions, executable by processor 12, to control gaming device 10. Memory device 14 also stores other data such as image data, event data, player input data, random or pseudo-random number generators, pay-table data or other operating data, information and applicable game rules that relate to the play of gaming device 10. In another embodiment, memory device 14 includes random access memory (RAM). In one embodiment, memory device 14 includes read only memory (ROM). In a further embodiment, memory device 14 includes flash memory and/or EEPROM (electrically erasable programmable read only memory). Any other suitable magnetic, optical and/or semiconductor memory may be implemented in conjunction with gaming device 10 of the present invention.

In one embodiment, part or all of the program code and/or operating data described above can be stored in a detachable or removable memory device, including, but not limited to, a suitable cartridge, disk or CD ROM. A player can use such a removable memory device in a desktop, a laptop personal computer, a personal digital assistant (PDA) or other computerized platform. Processor 12 and memory device may be collectively referred to herein as a “computer” or “controller.”

In one embodiment, as discussed in more detail below, gaming device 10 randomly generates awards and/or other game outcomes based on probability data. That is, each award or other game outcome is associated with a probability and gaming device 10 generates the award or other game outcome to be provided to the player based on the associated probabilities. In this embodiment, since gaming device 10 generates outcomes randomly or based upon a probability calculation, there is no certainty that gaming device 10 will provide the player with any specific award or other game outcome.

In another embodiment, as discussed in more detail below, gaming device 10 employs a predetermined or finite set or pool of awards or other game outcomes. In this embodiment, as each award or other game outcome is provided to the player, gaming device 10 removes the provided award or other game outcome from the predetermined set or pool. Once removed from the set or pool, the specific provided award or other game outcome cannot be provided to the player again. In this type of embodiment, gaming device 10 provides players with all of the available awards or other game outcomes over the course of the play cycle and guarantees a designated amount of actual wins and losses.

In one embodiment, as illustrated in FIG. 2A, gaming device 10 includes one or more display devices controlled by processor 12. The display devices are connected to or mounted to the cabinet of gaming device 10 in the illustrated embodiment. The embodiment shown in FIG. 1A includes a central display device 16 which displays a primary game. This display device may also display any suitable secondary game associated with the primary game as well as information relating to the primary or secondary game. The alternative embodiment shown in FIG. 1B includes a central display device 16 and an upper display device 18. The upper display device may display the primary game, any suitable secondary game associated with the primary game and/or information relating to the primary or secondary game. As seen in FIGS. 1A and 1B, in one embodiment, gaming device 10 includes a credit display 20 which displays a player's current number of credits, cash, account balance or the equivalent. In one embodiment, gaming device 10 includes a bet display 22 which displays a player's amount wagered.

The display devices may include, without limitation, a monitor, a television display, a plasma display, a liquid crystal display (LCD), a display based on light emitting diodes (LED) or any other suitable electronic device or display mechanism. In one embodiment, as described in more detail below, the display device includes a touchscreen with an associated touchscreen controller. The display devices may be of any suitable configuration, such as a square, a rectangle or an elongated rectangle.

The display devices of gaming device 10 are configured to display one or a plurality of games or other suitable images, symbols and indicia such as any visual representation or exhibition of the movement of objects such as mechanical, virtual or video reels and wheels, dynamic lighting, video images and images of people, characters, places, things and faces of cards, tournament advertisements, promotions and the like.

In one alternative embodiment, the symbols, images and indicia displayed on or by the display device may be in mechanical form. That is, the display device may include any suitable electromechanical device, which can move one or more mechanical objects, such as one or more mechanical rotatable wheels, reels or dice, configured to display one or a plurality of games or other suitable images, symbols or indicia.

As illustrated in FIG. 2A, in one embodiment, gaming device 10 includes at least one payment acceptor 24 in communication with processor 12. As seen in FIGS. 1A and 1B, the payment acceptor may include a coin slot 26 and a payment, note or bill acceptor 28, where the player inserts money, coins or tokens. The player can place coins in the coin slot or paper money, ticket or voucher into the payment, note or bill acceptor. In other embodiments, devices such as readers or validators for credit cards, debit cards, data cards or credit slips could be used for accepting payment.

In one embodiment, a player may insert an identification card into a card reader 60 of gaming device 10. Card reader 60 is operable with a dedicated keypad 62 or a keypad appearing on display device 16, 18, which cooperates with touch screen 42 and touch screen controller 44 to enable the player to enter passwords, process fund requests, cancel fund requests and the like.

The identification card can be a smart card having a programmed microchip or a magnetic strip coded with a player's identification, credit totals and other relevant information. In one embodiment, money may be transferred to a gaming device through electronic funds transfer. When a player funds gaming device 10, processor 12 determines the amount of funds entered and the corresponding amount is shown on the credit or other suitable display as described above. Card reader 60 alternatively or additionally accepts payment cards, such as credit cards or debit cards. Card reader 60 in one embodiment includes a magnetic strip reader as is known to those of skill in the art.

In one preferred embodiment described below, card reader 60 alternatively or additionally accepts a pre-purchased game-credit card having an amount of money stored thereon. The game-credit card can for example be a gift card that is given from the purchaser of the card to a beneficiary of the card. The beneficiary of the card can then take the card to authorized casinos and play authorized machines using the card. Operation of the pre-purchased game-credit card is described in more detail below. Payment acceptor 24 as used herein also refers to the pre-purchased game-credit card of the present invention.

Although not illustrated, gaming device 10 can provide a second card reader, like card reader 60. Here, one card reader is used to accept payment, e.g., from the game-credit card described in more detail below, while the second card reader accepts a player tracking card. The player tracking card can then be used simultaneously with the game-credit card. Alternatively, a single card reader is provided and processor 12 enables the player to insert the game-credit card and player tracking in a sequence, e.g., player tracking then game-credit, then player tracking again or game-credit then player tracking, so that the player receives player tacking benefits from playing with the game-credit card of the present invention

As seen in FIGS. 1A, 1B and 2A, in one embodiment gaming device 10 includes one or a plurality of input devices 30 in communication with processor 12. The input devices can include any suitable device which enables the player to produce an input signal which is read by processor 12. In one embodiment, after appropriate funding of gaming device 10, the input device is a game activation device, such as a pull arm 32 or a play button 34 which is used by the player to start any primary game or sequence of events in gaming device 10. The play button can be any suitable play activator such as a bet one button, a max bet button or a repeat the bet button. In one embodiment, upon appropriate funding, gaming device 10 begins the game play automatically. In another embodiment, upon the player engaging one of the play buttons, gaming device 10 automatically activates game play.

In one embodiment, as shown in FIGS. 1A and 1B, one input device is a bet one button 36. The player places a bet by pushing the bet one button. The player can increase the bet by one credit each time the player pushes the bet one button. When the player pushes the bet one button, the number of credits shown in the credit display decreases by one, and the number of credits shown in the bet display increases by one. In another embodiment, one input device is a bet max button (not shown) which enables the player to bet the maximum wager permitted for a game associated with gaming device 10.

In one embodiment, one input device is a cash out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms such as tickets or credit slips which are redeemable by a cashier or funded to the player's electronically recordable identification card.

In one embodiment, as mentioned above and seen in FIG. 2A, one input device is a touchscreen 42 coupled with a touchscreen controller 44, or some other touch-sensitive display overlay to allow for player interaction with the images on the display. The touchscreen and the touchscreen controller are connected to a video controller 46. A player can make decisions and input signals into gaming device 10 by touching the touchscreen at the appropriate places.

Gaming device 10 may further include a plurality of communication ports for enabling communication of processor 12 with external peripherals, such as external video sources, expansion buses, game or other displays, an SCSI port or a key pad.

In one embodiment, as seen in FIG. 2A, gaming device 10 includes a sound generating device controlled by one or more sounds cards 48 which function in conjunction with processor 12. In one embodiment, the sound generating device includes one or a plurality of speakers 50 or other sound generating hardware and/or software for generating sounds, such as playing music for the primary and/or secondary game or for other modes of gaming device 10, such as an attract mode. In one embodiment, gaming device 10 provides dynamic sounds coupled with attractive multimedia images displayed on at least one of the display devices to provide an audio-visual representation or to otherwise display full-motion video with sound to attract players to gaming device 10. During idle periods, gaming device 10 may display a sequence of audio and/or visual attraction messages to attract potential players to gaming device 10. The videos may also be customized for or to provide any appropriate information.

In one embodiment, the gaming machine may include a player or other sensor, such as a camera in communication with processor 12 (and possibly controlled by processor 12) that is selectively positioned to acquire an image of a player actively using gaming device 10 and/or the surrounding area of gaming device 10. In one embodiment, the camera may be configured to selectively acquire still or moving (e.g., video) images and may be configured to acquire the images in either an analog, digital or other suitable format. The display device may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

Gaming device 10 can incorporate any suitable wagering primary or base game. The gaming machine or device of the present invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation of the game from a wager made by the player. That is, different primary wagering games, such as video poker games, video blackjack games, video keno, video bingo or any other suitable primary or base game may be implemented into the present invention.

In one embodiment, as illustrated in FIGS. 1A and 1B, a base or primary game may be a slot game with one or more paylines 52. The paylines may be horizontal, vertical, circular, diagonal, angled or any combination thereof. In this embodiment, gaming device 10 displays one or a plurality of reels 54, such as three to five reels, in either electromechanical form with mechanical rotating reels or in video form with simulated reels and movement thereof. In one embodiment, an electromechanical slot machine includes a plurality of adjacent, rotatable wheels which may be combined and operably coupled with an electronic display of any suitable type. In another embodiment, if the reels are in video form, the plurality of simulated video reels are displayed on at least one of the display devices as described above. Each reel displays a plurality of indicia such as bells, hearts, fruits, numbers, letters, bars or other images which correspond in one embodiment to a theme associated with gaming device 10. In this embodiment, gaming device 10 awards prizes when the reels of the primary game stop spinning if specified types and/or configurations of indicia or symbols occur on an active pay line or otherwise occur in a winning combination or pattern.

In one embodiment, a base or primary game may be a poker game wherein gaming device 10 enables the player to play a conventional game of video poker and initially deals five cards, all face up, from a virtual deck of fifty-two cards. Cards may be dealt as in a traditional game of cards or in the case of gaming device 10, the cards may be randomly selected from a predetermined number of cards. If the player wishes to draw, the player selects the cards to hold by using one or more input devices, such as pressing related hold buttons or touching a corresponding area on a touchscreen. After the player presses the deal button, processor 12 of gaming device 10 removes the unwanted or discarded cards from the display and deals replacement cards from the remaining cards in the deck. This results in a final five-card hand. Processor 12 of gaming device 10 compares the final five-card hand to a payout table which utilizes conventional poker hand rankings to determine the winning hands. Award based on a winning hand and the credits wagered is provided to the player.

In another embodiment, the base or primary game may be a multi-hand version of video poker. In this embodiment, the player is dealt at least two hands of cards. In one such embodiment, the cards in all of the dealt hands are the same cards. In one embodiment each hand of cards is associated with its own deck of cards. The player chooses the cards to hold in a primary hand. The held cards in the primary hand are also held in the other hands of cards. The remaining non-held cards are removed from each displayed hand and replaced with randomly dealt cards. Since the replacement cards are randomly dealt independently for each hand, the replacement cards will usually be different for each hand. The poker hand rankings are then determined hand by hand and awards are provided to the player.

In one embodiment, a base or primary game may be a keno game wherein gaming device 10 displays a plurality of selectable indicia or numbers on at least one of the display devices. In this embodiment, the player selects one or a plurality of the selectable indicia or numbers by using an input device or by using the touchscreen. Gaming device 10 then displays a series of drawn numbers to determine an amount of matches, if any, between the player's selected numbers and the gaming device's drawn numbers. The player is provided an award, if any, based on the amount of determined matches.

In one embodiment, in addition to winning credits in a base or primary game, the gaming device may also give players the opportunity to win credits in a bonus or secondary game or bonus or secondary round. The bonus or secondary game enables the player to obtain a bonus prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In one embodiment, the bonus or secondary game may be any type of suitable game, either similar to or completely different from the base or primary game. In one embodiment, gaming device 10 includes a program code which causes processor 12 to automatically begin a bonus round when the player has achieved a triggering event, a qualifying condition or other designated game event in the base or primary game. In one embodiment, the triggering event or qualifying condition may be a selected outcome in the primary game or a particular arrangement of one or more indicia on a display device in the primary game, such as the number seven appearing on three adjacent reels along a payline in the primary slot game embodiment seen in FIGS. 1A and 1B. In another embodiment, the triggering event or qualifying condition may be triggered by exceeding a certain amount of game play (number of games, number of credits, amount of time), earning a specified number of points during game play or as a random award.

In one embodiment, once a player has qualified for a bonus game, the player may subsequently enhance their bonus game participation by returning to the base or primary game for continued play. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple bonus qualifying events in the primary game may result in an arithmetic or geometric increase in the number of bonus wagering credits awarded. In one embodiment, extra bonus wagering credits may be redeemed during the bonus game to extend play of the bonus game.

In one embodiment, no separate entry fee or buy in for a bonus game need be employed. That is, a player may not purchase an entry into a bonus game. The player must win or earn entry through play of the primary game, thereby encouraging play of the primary game. In another embodiment, qualification of the bonus or secondary game could be accomplished through a simple “buy in” by the player if, for example, the player has been unsuccessful at qualifying for the bonus game through other specified activities.

In one embodiment, as illustrated in FIG. 2B, at least one gaming device 10 of the present invention may be connected to a data network or a remote communication link 58 with some or all of the functions of each gaming device provided at a central location such as a central server or central controller 56. More specifically, processor 12 of each gaming device may be designed to facilitate transmission of signals between the individual gaming device and central server or controller 56.

In one embodiment, the game outcome provided to the player is determined by a central server or controller and provided to the player at the gaming device of the present invention. In this embodiment, each of a plurality of such gaming devices are in communication with central server or controller 56. Upon a player initiating game play at one of the gaming devices, the initiated gaming device communicates a game outcome request to central server or controller 56.

In one embodiment, central server or controller 56 receives the game outcome request and randomly generates a game outcome for the primary game based on probability data. In another embodiment, central server or controller 56 randomly generates a game outcome for the secondary game based on probability data. In another embodiment, central server or controller 56 randomly generates a game outcome for both the primary game and the secondary game based on probability data. In this embodiment, central server or controller 56 is capable of storing and utilizing program code or other data similar to processor 12 and memory device of gaming device 10.

In an alternative embodiment, central server or controller 56 maintains one or more predetermined pools or sets of predetermined game outcomes. In this embodiment, central server or controller 56 receives the game outcome request and independently selects a predetermined game outcome from a set or pool of game outcomes. Central server or controller 56 flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such a free games.

Central server or controller 56 communicates the generated or selected game outcome to the initiated gaming device. Gaming device 10 receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by central server or controller 56 and communicated to the initiated gaming device to be presented or displayed to the player. Central production or control can assist a gaming establishment or other entity in maintaining appropriate records, controlling gaming, reducing and/or preventing cheating or electronic or other errors, reducing or eliminating win-loss volatility and the like.

In another embodiment, at least one of the gaming devices of the present invention communicates with a central server or controller for monitoring purposes only. That is, each individual gaming device randomly generates the game outcomes to be provided to the player and central server or controller 56 monitors the activities and events occurring on the plurality of gaming devices. In one embodiment, the gaming network includes a real-time or an on-line accounting and gaming information system operably coupled to central server or controller 56. The accounting and gaming information system of this embodiment includes a player database for storing player profiles, a player tracking module for tracking players and a credit system for providing automated casino transactions.

A plurality of the gaming devices of the present invention are capable of being connected to a data network. In one embodiment, the data network is a local area network (“LAN”), in which at least one of the gaming devices are substantially proximate to each other and an on-site central server or controller as in, for example, a gaming establishment or a portion of a gaming establishment. In another embodiment, the data network is a wide area network (“WAN”) in which at least one of the gaming devices communicates with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system of the present invention may be substantially identical to the LAN gaming system described above, although the number of gaming devices in each system may vary relative to each other.

In another embodiment, the data network is an internet or intranet. In this embodiment, the operation of gaming device 10 can be viewed at the gaming device with at least one internet browser. In this embodiment, operation of gaming device 10 and accumulation of credits may be accomplished with only a connection to the central server or controller (the internet/intranet server or webserver) through a conventional phone or other data transmission line, digital signal line (DSL), T-1 line, coaxial cable, fiber optic cable, wireless gateway or other suitable connection. In this embodiment, players may access an internet game page from any location where an internet connection and computer, or other internet facilitator are available. The expansion in the number of computers and number and speed of internet connections in recent years increases opportunities for players to play from an ever-increasing number of remote sites. It should be appreciated that enhanced bandwidth of digital wireless communications may render such technology suitable for some or all communications according to the present invention, particularly if such communications are encrypted. Higher data transmission speeds may be useful for enhancing the sophistication and response of the display and interaction with the player.

In another embodiment, a plurality of gaming devices at one or more gaming sites may be networked to a central server in a progressive configuration, as known in the art, wherein a portion of each wager to initiate a base or primary game may be allocated to bonus or secondary event awards. In one embodiment, a host site computer is coupled to a plurality of the central servers at a variety of mutually remote gaming sites for providing a multi-site linked progressive automated gaming system. In one embodiment, a host site computer may serve gaming devices distributed throughout a number of properties at different geographical locations including, for example, different locations within a city or different cities within a state.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data communication between gaming device 10 hardware and software and the host site computer.

### Single Game Operation with Game-Credit Card

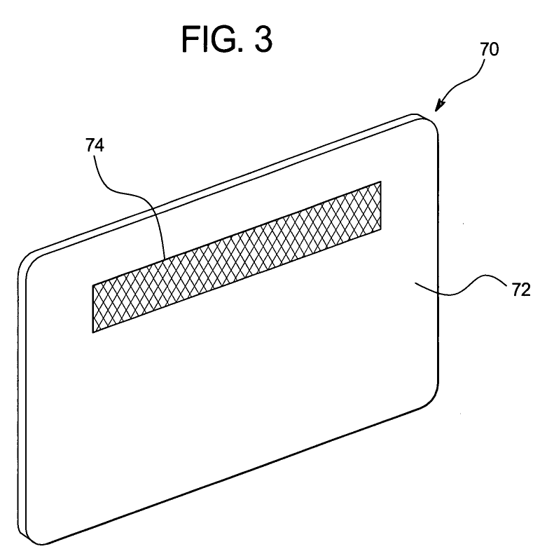

FIG. 2A illustrates that processor 12 operates with a payment acceptor 24. In one embodiment as described above in connection with FIGS. 1A and 1B, payment acceptor 24 includes a pre-purchased game-credit card reader 60. Processor 12 operates with software and memory device 14 to determine how much money or how many credits worth of money are stored on a game-credit card 70 illustrated in FIG. 3.

Any one or more of the following providers can issue card 70 of the present invention. A gaming device manufacturer, such as the assignee of the present invention, can issue pre-purchased game-credit card 70. Alternatively or additionally, a casino or group of casinos can issue the game-credit card 70 of the present invention. Further alternatively, a third person or party cooperating with the manufacturer or casino can issue the cards. The cards are issued to various outlets. The outlets include any type of service outlet, retail outlet, store, gaming device manufacturer, casino, promotional outlet or other type of distribution entity.

In an alternative embodiment, card 70 can be distributed through game-credit card kiosks, which can be located inside of a gaming establishment or in locations remote to the gaming establishment. In a further embodiment, game-credit cards can be purchased over an internet or other suitable data network, through the mail and any combination of the above outlets.

Game-credit card 70 includes a body or member 72 and a recordable medium 74 located thereon or therein. Member 72 is made of any suitable material, such as plastic, paper, paper board or other relatively durable, light and inexpensive material. In one embodiment, member 72 is sized to be at least approximately the same size as a standard credit or debit card, so that card 70 can be stored easily and transported by the owner or beneficiary of such card. Sizing card 70 to be the same or a very similar size as a standard credit or debit card also has the advantage of enabling card reader 60 to double as a credit card reader or as a reader of the game-credit card of the present invention.

Recordable medium 74 of card 70 in one embodiment is a magnetic strip, such as of the type found on currently available credit cards, debit cards and the like. Alternatively, medium 74 includes a bar code. Recordable medium 74 is operable so that a teller or other type of store or outlet personnel can record thereon an amount of money, which can then be used at authorized casinos and at authorized gaming devices. In general, recordable medium 74 is any suitable recording device for any suitable type of credit, debit, smart or other card 70. Game-credit card 70 is purchased in a similar manner as is done for example at retail stores, such as Home Depot®, or at service providers, such as Starbucks Coffee®. The teller or retailer in one embodiment formats card 70 to credit to the card any suitable amount of money desired by the purchaser.

In one embodiment, the card has a total maximum limit of money and can be credited, such as $1,000, and/or a minimum limit, such as a penny. Because most casinos do not provide machines that can accept a wager in an amount less than a penny, card 70 in one embodiment is limited to being credited in one-cent increments. It should be appreciated, however, that game-credit card 70 can be limited to being incremented or credited in any suitable denomination, such as nickels, dimes, quarters, dollars and multiples of dollars.

In another embodiment, card 70 is provided with an amount of money already programmed into memory strip 74, that is, it is not user settable. For example, the retail or other card outlet can provide the purchaser an option of purchasing a five-dollar game-credit card 70, a ten-dollar game-credit card, a twenty-five-dollar game-credit card, a fifty-dollar game-credit card and so on. In such cases, for security reasons, the retailer may first need to verify payment from the purchaser before activating the present card. Alternatively, the retailer credits the gift card 70 at the time of purchase by a preset amount displayed on the card or its packaging. That is, the card 70 itself is not initially credited even though the package specifies an amount. In still another alternative embodiment, the game-credit card outlet provides both options to the purchaser, so that the purchaser can purchase a “standard” card or a custom credited card 70 as desired.

In one alternative embodiment, the game-credits are not credited to a card that includes a member 72 and recordable medium 74. Instead, the purchaser purchases an authorization number or a bar-coded ticket having a purchased amount of money associated with it. The number can be used by the purchaser in an online casino web site or be emailed to a recipient or beneficiary, who then uses the authorization number in the online casino web site or the like. The web site could require additional information from the user of the card, such as the user's name, the purchaser's name, a birth date, maiden name and the like. The bar-coded ticket can be inserted into gaming device 10, for example, at ticket acceptor 28. This information is communicated over a user's personal computer, including a monitor and an inputting device, such as a keyboard and/or mouse.

In one embodiment, game-credit card 70 provides one or more additional benefits or incentives to the user of the card, such as game related incentives, wagering incentives, or any combination thereof. In one example, if card 70 is credited with fifty purchased dollars stored by or represented by the recordable medium 74, processor 12 of gaming device 10 can be configured to operate with memory device 14 and software to provide one or more additional benefits or incentives to the player who uses the card, wherein the benefit or incentive is above and beyond the fifty dollars. The benefit or incentive can be any suitable type of monetary or non-monetary incentive and can be provided in a game or in association with a game. The benefits or incentives contemplated by the present invention include any one or more of the following:

(i) one or more additional game credits provided for play by the player in a specific game;

(ii) one or more free spins or activations of a base game normally operable upon a wager by a player;

(iii) a non-monetary product incentive;

(iv) a non-monetary service incentive;

(v) a bonus game eligibility or a higher bonus game eligibility;

(vi) a bonus game payout enhancement;

(vii) an increased number or reduced number of elements in a base or bonus game;

(viii) a reduced number of termination events or partial termination events in a base or bonus game;

(ix) an extra number of tries, attempts, picks, or activations in a bonus game;

(x) an increase in a likelihood of entering a bonus game;

(xi) a base game payout enhancement such as a higher or better paytable;

(xii) a base game payout eligibility;

(xiii) an increase in a likelihood of achieving one or more base game wins such as one or more free paylines;

(xiv) a modified base game play;

(xv) a modified bonus game play;

(xvi) a likelihood of activating a secondary bonus event in a bonus game; and

(xvii) any combination of two or more of the above.

It should also be appreciated that a different symbol set, e.g., set having a higher expected value, or different symbol combinations, e.g., having enhanced graphics, can be employed in accordance with the present invention as the incentive. The gaming display may also be altered, e.g., upgraded when the player wagers using a gift card. Other suitable incentives may also be employed in accordance with the present invention. Further, the incentives may be initiated at any desirable point of use of game card 70, e.g., after 10, 20, 25, 30, 50 percent of the available card credits have been wagered. Such feature promotes the use of the card for gaming as opposed to redemption for money.

In one embodiment, gaming device 10 is configured to provide the player with an additional number of game credits for using the game-credit card 70. The number of additional game credits can be based on the amount of money purchased and credited to the game card 70. For example, gaming device 10 can be configured to provide an additional game credit for every twenty-five dollars worth of money purchased for game-credit card 70.

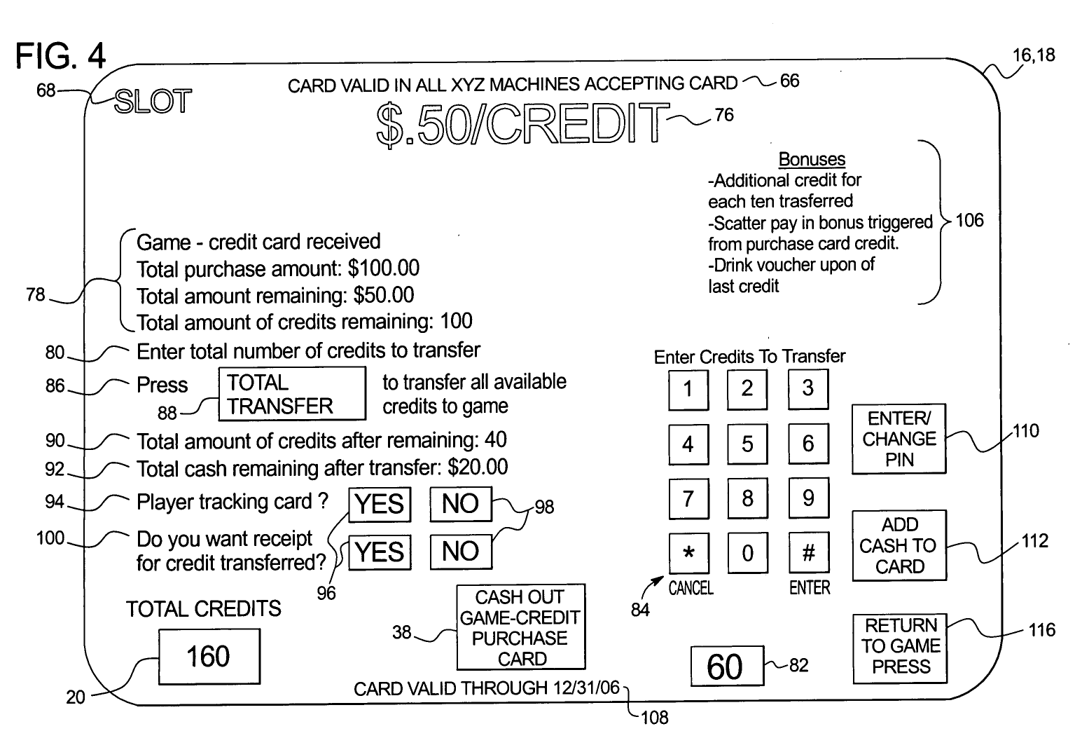

Referring now to FIG. 4, various embodiments for operating the game-credit card 70 of the present invention are illustrated by the screen shot displayed in one of display devices 16 or 18. The screen illustrated in FIG. 4 is displayed in one embodiment automatically upon inserting card 70 into card receiver 60. Alternatively, the player at any time can access the screen illustrated in FIG. 4 by pressing the access button 64 illustrated in FIGS. 1A and 1B. Input device 64 is alternatively a simulated input device displayed on one of the screens 16 and 18 illustrated in FIGS. 1A and 1B, which is operable with touch screen 42 and touch screen controller 44.

Referring now to FIG. 4, multitude of options for card 70 are illustrated. The present invention does not require any of the particular following options. Indeed, any combination of the features and options discussed in connection with FIG. 4 may be provided to operate the pre-purchased game-credit card 70. Further, while each of the features is illustrated below as being communicated visually to the player, it should be appreciated that any one or more or all of the features and options can alternatively or additionally be communicated audibly via speakers 50 to the player.

Message 66 informs the player that card 70 is valid in all “XYZ” machines accepting such cards. Message 66 includes a number of important points. First, the XYZ designation limits the machines in which card 70 may be used. Various groupings of authorized machines have already been discussed. For example, XYZ can refer to a manufacturer, a casino, a conglomerate of casinos or any combination thereof. Second, message 66 indicates that card 70 may be received in any XYZ machine accepting such cards. Older machines or machines not otherwise having a card receiver 60 would not accept card 70.

Message 68 indicates that card 70 is currently being used to input funds for a slot game. One of the advantages of the present invention is that card 70 may be used with a plurality of different types of gaming devices, which employ or play different types of games. Some of the games for which card 70 may be used include: slot, poker, keno, blackjack, bunco, checkers, craps and any combination thereof. It is expressly contemplated that card 70 of the present invention may be used to provide a certain number of credits to play slot, for example, after which the user retrieves card 70 and uses the card to thereafter play video poker, for example.

Message 76 indicates to the player that the player will spend fifty cents for each credit that the player decides to transfer from the card to gaming device 10. It is known that different gaming devices use different credit denominations. In one embodiment, card 70 may be used regardless of the credit denomination as long as the card has credited thereon at least one credit worth of money. Therefore, for a given amount of money on card 70, the card may be used to play different games employing different credit denominations, as long as the card stores one credit's worth of money.

Message 78 provides status information to the user. Message 78 informs the user that receiver 60 has properly received the card and that the operating system of machine 10 has recognized the card. Message 78 also informs the player that the total original purchase amount for the card is, for example, one hundred dollars. Message 78 further informs the player that the total amount remaining on the card is, for example, fifty dollars. That is, the player has already transferred fifty dollars worth of credits from card 70 to a gaming device 10, which can be different than a slot game, made by a different manufacturer than the manufacturer of the current gaming device or even played at a different casino or different gaming establishment than the casino or gaming establishment in which the current gaming device is housed.

In one embodiment recordable medium 74 of game-credit card 70 is re-recordable to update the amount of money transferred from card 70 and/or remaining on card 70. It should be appreciated that receiver 60 or a device operable with receiver 60 is also provided having the capability of recording information from the processor 12 of gaming device 10 onto recordable medium 74.

Message 80 prompts the player to enter an amount of available credits to transfer from card 70 to processor 12 of gaming device 10. That number of credits is shown and verified to the user via display 82. Display 82 operates with keypad 84 to enable the player to enter from the screen a number of credits, which is shown in display 82. Alternatively, the screen can prompt the user to use electromechanical keypad 62 to enter the desired number of credits into display 82. Further alternatively, the player enters an amount of money into gaming device 10, after which the machine converts the transferred amount of money to credits via the conversion shown in message 76. Any remaining money could be credited back to the player or paid via a handpay. Still further alternatively, gaming device 10 in one embodiment uses credits as needed from card 70 automatically upon insertion, negating the need to transfer credits for card 70 to gaming device 10. A suitable message, such as “card in use” and a credits remaining meter (not illustrated) are provided to suitably inform the player that the card is in use. Keypad 84 is not needed.

Message 80 highlights an embodiment where the player is able to transfer only a portion of the amount of money available on game-credit card 70 to processor 12 of machine 10. In an alternative embodiment, card 70 operates in a “one-shot” manner. That is, the total amount of money initially purchased and credited to card 70 is automatically converted to the maximum number of credits and transferred to machine 10. Any remaining amount of money could then be redeemed to the player from a handpay attendant or in the form of a ticket 104 from ticket printer 102 (FIGS. 1A and 1B). The lights on top of gaming device 10a and 10b in FIGS. 1A and 1B in one embodiment illuminate to signal the hand pay attendant.

Card 70 in one embodiment is not capable of storing credits from the machine, rather, card 70 transfers credits to the machine. The credits remain on the machine, including any wins from play with credits off of the game-credit card 70. For example, gaming device 10 could assume that if card 70 is loaded into gaming device 10, gaming device 10 is supposed to use credits from card 70 first before using any credits otherwise loaded or stored on machine 10. In this manner, any credits taken from card 70 are used immediately and only for wagering. The player must cash out from credit display 20, which accumulates wins and debits wagers. Wins in this manner stay on the machine.

Game-credit card 70 funds machine 10 but cannot accumulate wins or load credits onto machine 10 that are then simply cashed out. This feature prevents the player from transferring funds from card 70 and cashing out without playing. The player must play each credit transferred from card 70 in this arrangement. Also card 70 is configured in one embodiment so that it cannot store credits from the machine. The card is not a “one shot” type, however, and may be used at different times. The balance on the card though is decreased sequentially until no credits remain.

In another embodiment, card 70 does not actually store credits that are then transferred to machine 10. Instead card 70 stores a credit number or identifier. The credit number or identifier corresponds to a number of credits or amount of money that machine 10 can provide to the player. In one implementation, recordable medium 74 is a read/write type medium, which enables a server computer to keep track of the credits used from card 70 and adjust the credit number or identifier remaining on card 70, either intermittently or upon a cash out. Here, the player can use a portion of the credits enabled by card 70 at one server computer 56 and then use the card at another gaming device linked to another server computer 56, which recalls the reduced credit number or identifier. Such process may be repeated until all credits have been used and the credit number or identifier is reduced to zero.

Alternatively, recordable medium 74 is a read only medium, from which a server computer 56 can read identification information and an initial credit number or identifier indicating an initial amount of available credits. Upon communicating with a gaming device 10 using card 70 for a first time, server computer 56 recalls the initial credit number and enables a corresponding amount of gaming to occur. The credits are provided by the server 56 or game processor, not card 70. If the player uses only a portion of the initial credit number or identifier, server computer 56 stores the remaining amount of credits. The next time the player inserts card 70 into a machine 10 connected to that server computer 56, the server computer identifies the card 70 and recalls the remaining credit balance.

Further alternatively, machine 10 and card 70 could be made to operate so that gaming device 10 only accepts card 70 if all the money credited to card 70 is transferable to credits on gaming device 10. In a further alternative embodiment, as discussed above, card 70 stores a number of credits, each having the same credit value. Card 70 only works then in machines having a matching credit denomination. Processor 12, for example, compares the credit denominations of machine 10 and card 70 to ensure that they are the same. Still further alternatively, gaming device 10 can operate with multiple credit denominations and automatically play with the denomination specified by card 70.

In a further alternative embodiment, gaming device 10 via message 86 informs the player to press a total transfer input 88 to transfer all available credits to the game of gaming device 10. In this embodiment, if the player selects to transfer all available credits to gaming device 10 and has an amount of money remaining on card 70, gaming device can: (i) automatically invoke a hand pay; (ii) automatically print a ticket 104 having an amount of money bar coded thereon; and (iii) automatically resave the remaining amount of money to card 70.

Message 90 informs the player of the total amount of credits for gaming device 10 remaining after the player's transfer is complete. In the illustrated embodiment, forty of the one hundred credits remain credited to card 70 after the player transfers sixty credits to gaming device 10 as seen in display 82. Message 92 correspondingly shows the amount of money remaining after the monetary transfer from game-credit card 70 to gaming device 10. Because in the illustrated embodiment the player has transferred thirty of the fifty remaining dollars to gaming device 10, message 92 indicates that the player has twenty dollars worth of credits remaining on card 70.

Message 94 prompts the player to input whether the player has a player tracking card, and whether the player would like the player tracking card to account for subsequent game play with the transferred credits. “Yes” and “No” inputs 96 and 98, respectively, are provided to enable the player to input that the player wants or does not want play with game-credit card credits to be tracked. Pressing the “No” input 98 informs machine 10 that the player tracking card system will not track subsequent play.

“Yes” and “No” inputs 96 and 98 are also provided in connection with message 96, which asks the player whether the player wants a receipt 104 for the transfer of cash or credits from game-credit card 70 to gaming device 10 as indicated by message 100. If the player desires a receipt 104, processor 12 commands ticket or receipt printer 102 shown in FIGS. 1A and 1B to print a receipt 104 chronicling the transaction. FIG. 2A also illustrates figuratively that ticket/receipt printer 102 is connected operably in one embodiment to processor 12.

Display device 16 or 18 in FIG. 4 shows an additional credit display 20, which is shown originally in FIGS. 1A and 1B. FIG. 4 also shows a simulated version of a cash out button 38, shown also in FIGS. 1A and 1B. Cash out button 38 in FIG. 4 enables the player to cash out the game-credit purchase card 70 of the present invention. In an alternative embodiment, the game-credit purchase card 70 does not enable the player to cash out the money credited to card 70 in lieu of playing the credits. When the card cash out feature is provided, a mechanism can be provided to compensate the casino for funds provided to the player via the cash out. If the casino receives the initial proceeds from the purchase of card 70, cashing out card 70 at the casino would result in an exchange of funds and no compensation would be required. In an alternative embodiment, if the gaming device manufacturer receives the proceeds from the initial purchase of card 70, the gaming establishment in one embodiment sends a bill or invoice to the manufacturer or card distributor with a printout of the cash out transaction and the manufacturer or card distributor compensates the casino accordingly.

As discussed above, game-credit purchase card 70 in one embodiment provides a monetary or non-monetary incentive to the player to use the card 70. Message 106 illustrates three possibilities. A first bonus includes an additional credit for each 10 credits transferred. Here, the player could receive a total of twenty additional credits for wagering the entire one hundred dollars or two hundred total available credits on the fifty cent per credit machine.

A second bonus shown is that a scatter pay is provided in the bonus if the bonus is triggered from a credit wagered from the game-credit card. To this end, FIGS. 1A and 1B illustrate an additional meter 108, which shows the balance of credits transferred from game-credit card 70. In the illustrated embodiment, the player has one hundred and sixty total credits. The player has transferred sixty of those credits from card 70. The present invention expressly contemplates, as illustrated, that the player can either add to the number of card 70 credits transferred via one of the other payment acceptors 24 or the player can add credits from card 70 to an already existing balance on machine 10. In either case, in one embodiment after the player transfers credits from card 70, gaming device 10 proceeds to use credits transferred from card 70. Thus, if the player begins wagering on gaming device 10 as it is shown in FIGS. 1A, 1B and 4, the first sixty credits wagered will be credits from the game-credit card.

Referring again to the bonus message 106, if a bonus is triggered during play of the first sixty purchase card credits, the player obtains a scatter pay in that bonus or upon a certain event occurring in that bonus. A situation may arise, for example, when the player wagers multiple credits per play, such as nine credits, one on each of nine paylines. In that situation, upon the seventh of such plays, the player will have wagered a mix of credits transferred from card 70 and credits obtained from another payment acceptor 24. In this case, machine 10 can be operable to invoke the scatter bonus if even one purchase card credit is wagered, no scatter bonus if even one non-purchase card credit is wagered or provide the bonus only if a majority of the credits originates from card 70, for example. In alternative embodiments, use of the game-credit card causes the money or non-monetary incentive to apply to one or more or all plays until the player cashes out.

Message 106 also shows that the player receives a drink voucher, e.g., from ticket/receipt printer 102, upon the transfer of the last credit from card 72 of gaming device 10. None of the three bonuses illustrated by message 106 disadvantages the casino if the player presses cash out input 38 before playing any of the credits stored on card 70. In one embodiment, the player in essence has to use the credits from card 70 on machine 10 to obtain any of the illustrated bonuses.

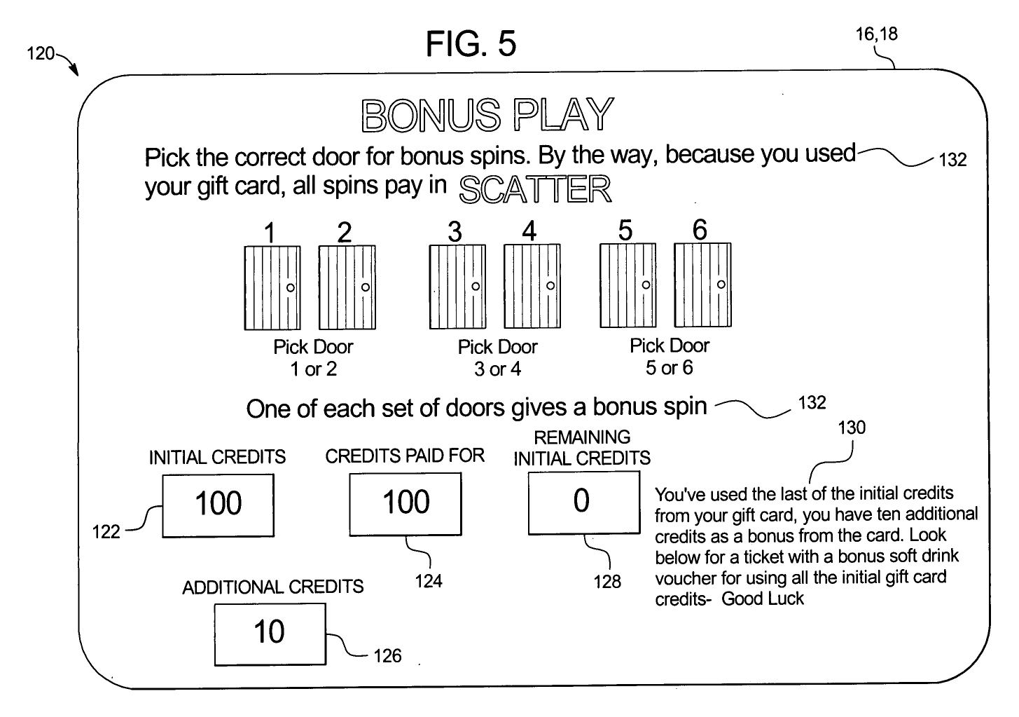

In other embodiments, the card could store the bonus amount. For example, if one hundred dollars is purchased and applied to card 70, card 70 could store the one hundred dollars plus a bonus amount, such as two dollars or five dollars. In such a case, if the player is allowed to cash out and redeem the total amount including the bonus amount, the issuer and/or distributor of the card would be required to compensate the gaming establishment for the additional money. Again, processor 12 or a network in communication with processor 12 can keep track of such money and send an invoice or a bill to the issuer or distributor of the card. The bonus amount may vary depending on the purchase amount of the card, e.g., a $50 card receives a $1 bonus, while a $100 card receives a $2 bonus. FIG. 5 discussed below illustrates the bonus features of the game-credit card 70 in more detail.

Message 108 shows that the card can have an expiration date or time limit. Such time limit or expiration is helpful for accounting purposes, so that the issuer of the card can forecast how much money exists at any current time on the cards as well as to know the last possible date the money can be used.

Input devices 110 and 112 illustrate two additional features, which are optional in one embodiment. Input device 110 enables the player to enter or change a personal identification number (“PIN”). In one embodiment, the player enters the PIN via one or the other of keypad 62 and 84. The PIN number, if entered, prevents card 70 from being used if lost or stolen. Therefore, the PIN number serves as a deterrent to theft.

A second optional feature initiated by input 112 enables the player to add additional funds to game-credit card 70. When pressed, screen 16 or 18 prompts the player to insert money in one of the alternative payment acceptors 24, which then is credited or transferred to card 70. Card 70 therefore can act as an additional form of money that the player can readily transport to and from the gaming establishment. To that end, credits won on gaming device 10 can be paid out in a total cash out onto card 70 in one embodiment.

Input device 116 enables the player to return to base game play. In one embodiment, gaming device 10 enables the player to cancel a game-credit card transfer at any time during a card transfer and return to the base game.

Referring now to FIG. 5, a screen shot of the display device 16 or 18 of gaming device 10 is illustrated as screen 120. Screen 120 further describes the bonus games mentioned in connection with FIG. 4 via message 106. Screen 120 includes an initial credits display 122, a credits paid for display 124, and additional credits display 126 and a remaining initial credits display 128. Those displays illustrate that the player received one hundred initial credits from the player's game-credit card 70. The player or a donator of card 70 paid for the one hundred credits as shown in display 124. Display 126 shows the player that the player eventually receives ten additional or bonus credits, a first one of the monetary incentives or bonuses discussed above in connection with FIG. 4. Display 128 illustrates that the player has consumed or used all of the initial credits.

Because the player has used or consumed all of the one hundred initial credits, the player is now eligible to wager the bonus or additional credits shown in display 126. A suitable audio, visual or audio visual message 130 is provided. The message informs the player that the player has used the last of the initial credits from card 70 and that the player has an additional bonus of ten credits from the card. The message also refers to the player to look below at the output of ticket printer 102 for a ticket 104. The ticket 104, a second one of the monetary incentives or bonuses discussed above in connection with FIG. 4, is redeemable for in this case a soft drink and is again provided for using all of the initial one hundred credits. Ticket 104 can have any suitable type of bonus imprinted thereon. The bonus can be in monetary or non-monetary bonus. A non-monetary bonus is for example, a soft drink, meal or other service or product provided by the casino or gaming establishment.

As discussed herein, it is desirable in one embodiment to make certain bonuses provided by game-credit card 70 contingent upon the player wagering each of the initially purchased credits. That way the player cannot simply insert card 70 and redeem all credits including the bonus credits without playing gaming device 10. The additional credits and drink ticket are contingent upon the wager of a designated plurality or each of the initial one hundred credits.

Screen 120 also provides an audio, visual or audio visual message 132 informing the player that the previous play has placed the player in a bonus stage or game play mode. The message 132 describes one possible bonus game. It should be appreciated that the additional monetary benefits provided by the game-credit card 70 of the present invention can be implemented in a virtually unlimited number or variety of bonus games.

Screen 120 and message 132 highlight that the bonus game, which is played regardless of whether the player uses game-credit card 70, pays the player for each bonus spin in a scatter pay arrangement, the third bonus or incentive discussed above in connection with FIG. 4. Message 132 instructs the player to pick one of two doors in each of three pairs 1 or 2, 3 or 4 and 5 or 6. One of each of those pairs of doors yields to the player a free spin. If the player does not enter the bonus using credits from the game-credit card 70, gaming device 10 pays for the free spins according to the normal pay table for, e.g., a slot game. Because the player has entered the bonus game using a game-credit card 70 credit, the game pays in the more lucrative scatter format. Again, such additional incentive or bonus is based on game play and the player is not able to obtain this bonus and avoid the intent of the game-credit card, which is to promote game play.

### Networked Operation with Game-Credit Card

As discussed above, one or more or all of the functions of processor 12 is alternatively performed by a central controller 56 and a communications link 58 as seen in FIG. 2B. The present invention contemplates at least the following purchase card networks: (i) networking the same type of gaming devices, e.g., all slots, within a casino, (ii) networking gaming devices manufactured by the same manufacturer within a casino, (iii) networking the same type of gaming devices manufactured by different manufacturers within the same casino, (iv) networking different types of gaming devices manufactured by different casinos; and (v) networking any of the above four categories in different casinos. The present invention therefore expressly contemplates that multiple casinos and/or multiple casino owners can cooperate and issue a single card which carries an amount of money that may be used at any of the participant casinos, for example, at designated or authorized machines.

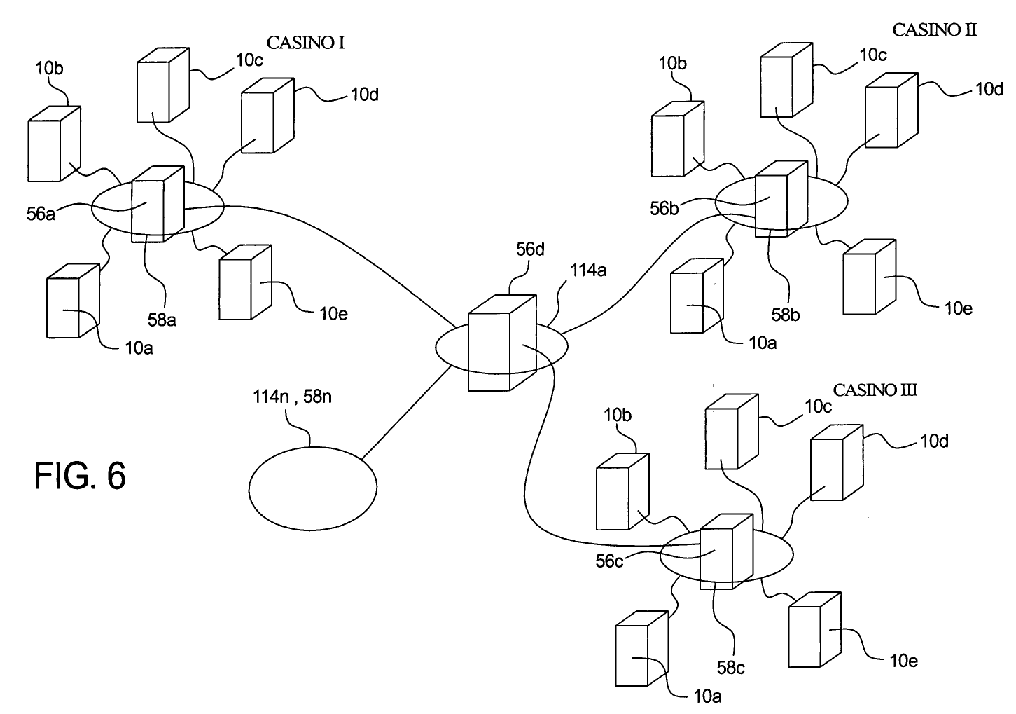

Referring additionally to FIG. 6, one example of multiple data networks is illustrated to show how multiple casinos can be linked together to track the player's usage of card 70. The interconnection of gaming devices 10 within each casino and throughout the different casinos would obviate the need for card 72 itself to keep track of any additional credits remaining on the card after game play or for a device within gaming device 10 that encodes or records such information on recordable medium 74 of card 70. A central server, such as server 56a (within casino) to 56d (outside of casino), keeps track of the amount of credits transferred from card 70 and the location and machine at which such transfer has taken place. The network and server computers also maintain the status of each of the features and functions illustrated in connection with FIG. 4.

FIG. 6 illustrates three local area networks (“LANs”) 58a to 58c. Those local area networks are linked by a wide area network 114a. Wide area network 114a in turn communicates with any additional number of wide area networks or local area networks, represented by element numbers 114n and 58n, respectively. The networks enable a player playing gaming device 10c at Casino 1 to transfer less than all of the credits from game-credit card 70 to gaming device 10c and thereafter transport the card to Casino 3, for example, where the player plays gaming device 10a using card 70. The two gaming devices again can be of the same or different type and have the same or different credit denomination. Afterward, the player can travel to Casino 2 and play gaming device 10d and continue such gaming until each of the credits is transferred from card 70 to one of the gaming devices 10.

Each time the player inserts the card, the corresponding local area network 58 (referring collectively to LAN's 58a to 58c) transfers information concerning the card to the wide area network 114a. The game also transports information to the local area servers 56 (referring collectively to servers 56a to 56c). Therefore, if the player plays a new gaming device 10 using card 70 within the same casino, the new gaming device 10 can receive information from the corresponding local area server 56 over the relevant LAN. When the player moves to a different casino, the information is transferred from the former casino over the wide area network to the local area network of the new casino and eventually to gaming device 10 in the new casino.

The wide area network in one embodiment can include an internet. The local area networks in various embodiments can be a pre-existing network, such as player tracking network or a ticketing network. In an alternative embodiment, a separate network is installed in the casino for keeping track of the game-credit cards 70 of the present invention.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gaming device operated under control of a processor, said gaming device comprising:
a display device controlled by the processor;
a game controlled by the processor and operable upon a placement of a wager by a player;
a game-credit card receiver operable with the processor, wherein the receiver and the processor cooperate to (i) receive a game-credit card from the player, and (ii) activate a purchased amount of money identified by the game-credit card, the purchased amount of money convertible to a number of game credits that the player can use to place the wager and play the game; and
wherein use of the game-credit card cause a game related play incentive to be provided to the player in addition to the purchased amount of money.

2. The gaming device of claim 1, wherein the game is selected from the group consisting of: slot, poker, keno, blackjack, bunco, checkers, craps and any combination thereof.

3. The gaming device of claim 1, wherein the game-credit card receiver is sized and configured to receive the game-credit card and at least one other card selected from the group consisting of: a player tracking card, a credit card and a debit card.

4. The gaming device of Clam 1, which includes a player tracking card receiver operable with the processor in addition to the game-credit card receiver.

5. The gaming device of claim 1, wherein the game-credit card receiver includes a magnetic strip reader operable to read a magnetic strip of the game-credit card.

6. The gaming device of claim 1, wherein the game is accessed via a computer network, the display device is a computer monitor and the game-credit card receiver includes a numerical input device.

7. The gaming device of claim 1, which includes a receipt printer operable with the processor, the receipt printer configured to print a receipt showing an amount of game credits from the game-credit card that have been used to play the game.

8. The gaming device of claim 1, wherein the display device is operable to display at least one of: the number of game credits provided by the game-credit card; a number of credits available to the player based on the denomination of the gaming device; a number of game-credit card credits used during play of the game; and a number of game-credit card credits remaining after play of the game.

9. The gaming device of claim 1, which includes an input device operable with the processor to enable the player to select a number of game credits to transfer from the game-credit card to play the game, the number indicated to the player by a credit meter.

10. The gaming device of claim 9, wherein at least one of the input device and the credit meter is displayed by the display device.

11. The gaming device of claim 1, wherein the game is configured to additionally provide the player with a number of additional credits above credits from the purchased amount of money for using the game-credit card.

12. The gaming device of claim 11, wherein the number of additional game credits is variable based on an amount of money spent to purchase the game-credit card.

13. The gaming device of claim 1, which includes a credit meter operable with the processor to indicate a first number of game credits transferred from the game-credit card in combination with a second number of credits inputted from at least one source selected from the group consisting of: cash, tokens, a credit card, a debit card and a ticket.

14. The gaming device of claim 1, wherein the game related play incentive is selected from the group consisting of: a bonus game eligibility, a bonus game payout enhancement, an extra number of tries in a bonus game, an increase in a likelihood of entering a bonus game, a base game payment enhancement, a base game payment eligibility, an increase in a likelihood of achieving one or more base game plays, a modified base game display, a modified bonus game display a likelihood of activating a secondary bonus event in a bonus game and any combination thereof.

15. A gaming device operated under control of a processor, said gaming device comprising:
a display device controlled by the processor;
a game controlled by the processor and operable upon a placement of a wager by a player;
a game-credit card receiver operable with the processor, wherein the receiver and the processor cooperate to (i) receive a game-credit card from the player, and (ii) activate a purchased amount of money identified by the game-credit card, the purchased amount of money convertible to a number of game credits that the player can use to place the wager and play the game; and
wherein the game-credit card causes an incentive to be provided to the player for using the game-credit card, the incentive selected from the group consisting of: (i) a bonus game eligibility, (ii) a bonus game payout enhancement, (iii) an extra number of tries in a bonus game, (iv) an increase in a likelihood of entering a bonus game, (v) a base game payment enhancement, (vi) a base game payment eligibility, (vi) an increase in a likelihood of achieving one or more base game plays, (vii) a modified base game display, (viii) a modified bonus game display, (ix) a likelihood of activating a secondary bonus event in a bonus game, and (x) and any suitable combination thereof.

16. The gaming device of claim 15, wherein the game-credit card enables the player to be provided a number of additional credits above credits from the purchased amount of money for using the game-credit card.

17. The gaming device of claim 15, wherein the processor is: (i) located in a cabinet supporting the display device and game-credit card receiver or (ii) located remotely from the cabinet supporting the display device and game-credit card receiver.

18. The gaming device of claim 15, wherein the processor is operable to obtain credits using the game-credit card as needed.

19. The gaming device of claim 18, wherein the processor is operable to obtain credits from the game-credit card as needed.

20. A gaming device operated under control of a processor, said gaming device comprising:
a display device controlled by the processor;
a game controlled by the processor and operable upon a placement of a wager by a player;
a game-credit card receiver operable with the processor, wherein the receiver and the processor cooperate to (i) receive a game-credit card from the player, and (ii) activate a purchased amount of money identified by the game-credit card, the purchased amount of money convertible to a number of game credits that the player can use to place the wager and play the game; and
wherein the processor includes provides a game related incentive after the player wagers at least a portion of the purchased amount of money on the game.
